(19) United States
(12) Patent Application Publication
(10) Pub. No.: US 2025/0131694 A1
(43) Pub. Date: Apr. 24, 2025

(54) Learning with Neighbor Consistency for Noisy Labels

(71) Applicant: Google LLC, Mountain View, CA (US)

(72) Inventors: Ahmet Iscen, Grenoble (FR); Jack Louis Valmadre, Grenoble, Auvergne-Thone-Alpes (FR); Anurag Arnab, Grenoble (FR); Cordelia Luise Schmid, Saint-Ismier (FR)

(21) Appl. No.: 18/688,257

(22) PCT Filed: Sep. 9, 2021
(86) PCT No.: PCT/IB2021/000900

§ 371 Date: Feb. 29, 2024

(51) Int. Cl. G06V 10/774; G06V 10/74; G06V 10/764; G06V 10/77; G06V 10/776; G06V 10/82; G06V 20/70

(52) U.S. Cl. CPC G06V 10/774; G06V 10/761; G06V 10/764; G06V 10/7715; G06V 10/776; G06V 20/70; G06V 10/82

(57) ABSTRACT

Systems and methods for classification model training can use feature representation neighbors for mitigating label training overfitting. The systems and methods disclosed herein can utilize neighbor consistency regularization for training a classification model with and without noisy labels. The systems and methods can include a combined loss function with both a supervised learning loss and a neighbor consistency regularization loss.

### FIELD

The present disclosure relates generally to training one or more machine-learned models based at least in part on the classifications for inputs with associated embeddings. More particularly, the present disclosure relates to joint supervised training and neighbor consistency regularization.

### BACKGROUND

While deep learning can achieve unprecedented accuracy in image classification tasks, deep learning can rely on having a large, supervised dataset that can be expensive to obtain. Unsupervised and semi-supervised learning can seek to alleviate the reliance by incorporating unlabeled examples. However, these approaches may not take advantage of the various sources of noisy labels, which are available in the modern world, such as images posted to social media under a given hashtag or images contained in webpages retrieved by a textual query. Training algorithms that are robust to label noise can therefore be highly attractive for deep learning.

Current label propagation methods can utilize graph edges of a global graph for propagating labels based on a learned feature representation space. However, use of current label propagation methods can cause underfitting and may be computationally expensive. Overfitting and underfitting of labels can cause misclassification issues.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for training a classification model. The method can include obtaining, by a computing system including one or more processors, a training dataset. In some implementations, the training dataset can include a first input and a second input. The method can include processing, by the computing system, the first input with an encoder model to generate a first embedding. The method can include processing, by the computing system, the first embedding with a classification model to generate a first classification. The method can include processing, by the computing system, the second input with the encoder model to generate a second embedding. In some implementations, the method can include processing, by the computing system, the second embedding with the classification model to generate a second classification. The method can include determining, by the computing system, a similarity measure between the first embedding and the second embedding based on a feature similarity. The method can include evaluating, by a computing system, a loss function. In some implementations, the loss function can include a loss term that evaluates a difference between the first classification and the second classification weighted by the similarity measure. The method can include adjusting, by the computing system, one or more parameters of the classification model based at least in part on the loss function.

In some implementations, the computer-implemented method can be a computer-implemented method for improved learning with noisy labels.

The method can include evaluating, by the computing system, a second loss function that evaluates a difference between the first classification and a first label and adjusting, by the computing system, one or more parameters of the classification model based at least in part on the second loss function. In some implementations, the first label can include a respective label for the first input, and the first label can be obtained from the training dataset. The second loss function can include a cross entropy loss function. In some implementations, the loss function and the second loss function can be weighted portions of a combined loss function. The loss function can include a neighbor consistency regularization loss function. The neighbor consistency regularization loss function can be configured to penalize a divergence of a predicted classification of a particular embedding from a weighted combination of predicted neighbor classifications for one or more neighboring embeddings to the particular embedding in an embedding space. In some implementations, the neighbor consistency regularization loss function can be configured to penalize a divergence of a predicted classification of a particular embedding from a weighted combination of predicted neighbor classifications for one or more neighboring embeddings to the particular embedding in an embedding space. The first input can include one or more first images, the second input can include one or more second images, and the first classification and the second classification can be image classifications. In some implementations, the classification model and the encoder model can be jointly trained. The encoder model can be a newly initialized model. The first embedding can include a first feature representation, the second embedding can include a second feature representation, and the feature similarity can be determined based at least in part on the second feature representation comprising one or more similar features to the first feature representation.

In some implementations, the second input can include a minibatch including a plurality of training inputs. In some implementations, generating the second embedding can include: processing the minibatch with the encoder model to generate a plurality of embeddings for the training inputs of the minibatch; processing the plurality of embeddings for the training inputs of the minibatch with the classification model to generate a plurality of classifications for the training inputs of the minibatch; determining one or more particular ones of the plurality of embeddings for the training inputs of the minibatch associated with the first embedding; and determining the second embedding based on the one or more particular ones of the plurality of embeddings.

In some implementations, determining the one or more particular embeddings for the training inputs of the minibatch associated with the first embedding can include determining a cosine similarity between the first embedding and each of the plurality of embeddings for the training inputs of the minibatch. The minibatch can include randomly selected training inputs from a training input database. In some implementations, the minibatch can include a balanced training data set, in which the minibatch includes an equal amount of training inputs for each of a plurality of predetermined classifications. The loss function can include a bootstrapping loss function. In some implementations, the method can include obtaining a first input label. In some implementations, evaluating the loss function can include evaluating a difference between the first classification and the first input label, and the one or more parameters can be adjusted based at least in part on the first input label.

A computer-implemented method of classifying an input with a classification model can include: obtaining input data; processing the input data with an encoder model to generate an input embedding, in which the input embedding includes an embedding in an embedding space; processing the input embedding with a classification model to generate an output classification, in which the classification model is the trained classification model; and providing the output classification for the input data.

In some implementations, the input data can include image data, and the output classification can include one or more object classifications based on one or more features in the image data. The output classification can include a prediction score descriptive of a level of certainty for one or more possible classifications.

In some implementations, one or more non-transitory computer-readable media that collectively store instructions that, when executed by one or more computing devices, can cause the one or more computing devices to perform the method. In some implementations, a computing system can include one or more processors and the one or more non-transitory computer-readable media.

Another example aspect of the present disclosure is directed to a computing system for improved learning with noisy labels. The computing system can include one or more processors and one or more non-transitory computer-readable media that collectively store instructions that, when executed by the one or more processors, cause the computing system to perform operations. The operations can include obtaining a first image and processing the first image with an encoder model to generate a first embedding in an embedding space. The operations can include processing the first embedding with a classification model to generate a first classification for the first image and obtaining a minibatch. In some implementations, the minibatch can include a plurality of training images. The operations can include processing the minibatch with the encoder model to generate a plurality of second embeddings in the embedding space for the respective plurality of training images and processing the plurality of second embeddings with the classification model to generate a plurality of second classifications. The operations can include determining one or more particular second embeddings are associated with the first embedding and determining a predicted classification for the first image based on the one or more particular second embeddings. The operations can include evaluating a loss function that evaluates a difference between the first classification and the predicted classification. In some implementations, the loss function can be configured to penalize a divergence of the first classification of the first embedding from a weighted combination of predicted neighbor classifications for one or more neighboring embeddings to the first embedding in the embedding space. The operations can include adjusting one or more parameters of the classification model based at least in part on the loss function.

In some implementations, determining the one or more particular second embeddings are associated with the first embedding can include determining a cosine similarity between the first embedding and each of the plurality of second embeddings. The minibatch can include randomly selected training images from a training image database. In some implementations, the minibatch can include a balanced training data set, in which the minibatch includes an equal amount of training images for each of a plurality of predetermined classifications. The loss function can include a bootstrapping loss function. The operations can include obtaining a first image label. Evaluating the loss function can include evaluating a difference between the first classification and the first image label, and the one or more parameters can be adjusted based at least in part on the first image label.

Another example aspect of the present disclosure is directed to one or more non-transitory computer-readable media that collectively store instructions that, when executed by one or more computing devices, cause the one or more computing devices to perform operations. The operations can include obtaining input data and processing the input data with an encoder model to generate an input embedding. In some implementations, the input embedding can include an embedding in an embedding space. The operations can include processing the input embedding with a classification model to generate an output classification. In some implementations, the classification model can be trained with a loss function, in which the loss function includes a supervised learning loss function and a neighbor consistency regularization loss function. The operations can include providing the output classification for the input data.

In some implementations, the input data can include image data, and the output classification can include one or more object classifications based on one or more features in the image data. The output classification can include a prediction score descriptive of a level of certainty for one or more possible classifications. In some implementations, training the classification model can include: obtaining a first training data and a minibatch comprising a plurality of second training data sets; processing the first training data and the minibatch with the encoder model to generate a first embedding and a plurality of second embeddings; processing the first embedding and the plurality of second embeddings with the classification model to generate a first classification for the first training data and a plurality of second classifications for the plurality of second training data sets; determining a predicted classification for the first training data based on one or more particular second embeddings of the plurality of second embeddings; evaluating a loss function that evaluates a difference between the first classification and the predicted classification; and adjusting one or more parameters of the classification model based at least in part on the loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs classification model training according to example embodiments of the present disclosure.

FIG. 1B depicts a block diagram of an example computing device that performs classification model training according to example embodiments of the present disclosure.

FIG. 1C depicts a block diagram of an example computing device that performs classification model training according to example embodiments of the present disclosure.

FIG. 2 depicts a block diagram of an example training process according to example embodiments of the present disclosure.

FIG. 3 depicts a block diagram of an example neighbor consistency regularization process according to example embodiments of the present disclosure.

FIG. 4 depicts a block diagram of an example supervised learning process according to example embodiments of the present disclosure.

FIG. 5 depicts a block diagram of an example combined training process according to example embodiments of the present disclosure.

FIG. 6 depicts a flow chart diagram of an example method to perform classification model training according to example embodiments of the present disclosure.

FIG. 7 depicts a flow chart diagram of an example method to perform machine-learned model training according to example embodiments of the present disclosure.

FIG. 8 depicts a flow chart diagram of an example method to perform classification with a machine-learned model according to example embodiments of the present disclosure.

FIG. 9 depicts line graphs of example model experimental results according to example embodiments of the present disclosure.

Reference numerals that are repeated across plural figures are intended to identify the same features in various implementations.

### DETAILED DESCRIPTION

### Overview

Generally, the present disclosure is directed to systems and methods for training a classification model with a neighbor consistency regularization. The systems and methods for training a classification model can include obtaining a training dataset, in which the training dataset can include a first input and a second input. In some implementations, the systems and methods can include processing the first input with an encoder model to generate a first embedding. The first embedding can be processed with a classification model to generate a first classification. In some implementations, the second input can be processed with the encoder model to generate a second embedding. The second embedding can be processed with the classification model to generate a second classification. In some implementations, the systems and methods can include determining a similarity measure between the first embedding and the second embedding. The first classification, the second classification, and the similarity measure can be used to evaluate a loss function. The loss function can then be used to adjust one or more parameters of the classification model.

In some implementations, the training dataset can include a minibatch. The minibatch can include a plurality of second inputs. The plurality of second inputs can be processed with the encoder model to generate a plurality of second embeddings. The plurality of second embeddings can be compared to the first embedding to determine the one or more particular second embeddings associated with the first embedding. The plurality of second embeddings can be processed with the classification model to generate a plurality of second classifications. The second classifications for the one or more particular second embeddings may then be used to generate a predicted classification for the first input. The predicted classification and the first classification can then be compared in order to evaluate a loss function. The loss function can then be used to modify one or more parameters of the classification model. In some implementations, one or more parameters of the encoder model may be adjusted based at least in part on the loss function.

The trained classification model and trained encoder model can then be utilized for various classification tasks.

The systems and methods can overcome the limitations of label propagation by 1) adapting label propagation to an inductive setting and by 2) applying the smoothness constraint directly during the optimization. In some implementations, the systems and methods can generalize label propagation by enforcing smoothness in the form of a regularizer. As a result, the systems and methods can avoid constructing an explicit graph to propagate the information, and inference can be performed on any unseen test example.

The systems and methods can be online and may train the model(s) without the use of a global graph. Moreover, the systems and methods may enforce the neighbor consistency regularization through the local neighborhood as the feature space is being learned. As a result, the systems and methods may process noisy examples without using a learned feature representation. The systems and methods can therefore enrich the learned feature representation by reducing the negative impact of noisy examples.

The systems and methods disclosed herein can use embeddings (e.g., feature representations) to train one or more machine-learned models. In some implementations, the one or more machine-learned models can include a convolutional neural network. The one or more machine-learned models can include an encoder model and a classification model. The encoder model can include a feature extractor, and the classification model can include a classifier. The feature extractor of the encoder model can be trained to map an input (e.g., an image) to a d-dimensional vector. The classifier of the classification model can be trained to determine class prediction scores based on the vector. In some implementations, the systems and methods can include a two-part loss function that can simultaneously train the one or more machine-learned models based on labels and based on classifications for feature representation neighbors. The two-part loss function can train a model to minimize the distance between logits with similar feature representations, while training for known labels.

The systems and methods can include obtaining a training dataset. The training dataset can include a first input and a second input. In some implementations, the first input can include a first image. Additionally, the second input can include a second image.

The first input (e.g., a first image) can be processed with an encoder model to generate a first embedding. In some implementations, the first embedding can be an embedding in an embedding space. The encoder model can include a feature extractor model for generating feature representations. In some implementations, the encoder model can include a sub-block for ReLU non-linearity.

The first embedding can then be processed with a classification model to generate a first classification. The classification can include an image classification for a first image. In some implementations, the classification can include one or more object classifications for one or more objects in an image. The classification can include a logit, a softmax output (e.g., the softmax layer output of the logit), and/or one-hot outputs (e.g., a binary prediction of whether the input includes the particular class or not).

Alternatively and/or additionally, the first input can include other data, such as audio data, and the classification can include an audio classification. As another example, the inputs can be Internet resources (e.g., web pages), documents, or portions of documents or features extracted from Internet resources, documents, or portions of documents, and the output generated by the classification model for a given Internet resource, document, or portion of a document may be a score for each of a set of topics, with each score representing an estimated likelihood that the Internet resource, document, or document portion is about the topic.

As another example, the inputs can include features of a personalized recommendation for a user (e.g., features characterizing the context for the recommendation (e.g., features characterizing previous actions taken by the user)), and the output generated by the classification model may be a score for each of a set of content items, with each score representing an estimated likelihood that the user will respond favorably to being recommended the content item.

As another example, the input can include a sequence of text in one language, and the output generated by the classification model may be a score for each of a set of pieces of text in another language, with each score representing an estimated likelihood that the piece of text in the other language is a proper translation of the input text into the other language.

As another example, the input can include a sequence representing a spoken utterance, and the output generated by the classification model may be a score for each of a set of pieces of text, each score representing an estimated likelihood that the piece of text is the correct transcript for the utterance.

The input may include, for example, one or more of: image data, moving image/video data, motion data, speech data, audio data, an electronic document, data representing a state of an environment, and/or data representing an action. For example, the image data may comprise color or monochrome pixel value data. Such image data may be captured from an image sensor such as a camera or LIDAR sensor. The audio data may include data defining an audio waveform such as a series of values in the time and/or frequency domain defining the waveform; the waveform may represent speech in a natural language. The electronic document data may include text data representing words in a natural language. The data representing a state of an environment may include any sort of sensor data including, for example: data characterizing a state of a robot or vehicle, such as pose data and/or position/velocity/acceleration data; or data characterizing a state of an industrial plant or data center such as sensed electronic signals such as sensed current and/or temperature signals. The data representing an action may include, for example, position, velocity, acceleration, and/or torque control data or data for controlling the operation of one or more items of apparatus in an industrial plant or data center. These data sets may, generally, relate to a real or virtual (e.g., a simulated environment).

The output data of classification model may similarly include any sort of data.

The second input can be processed with the encoder model to generate a second embedding. In some implementations, the second input can be part of a minibatch. The minibatch can include a plurality of second inputs. The plurality of second inputs can include a plurality of training images. In some implementations, the minibatch can be processed with the encoder model to generate a plurality of second embeddings for the respective plurality of second inputs (e.g., the plurality of training images). The minibatch can include randomly selected training images from a training image database. Alternatively and/or additionally, the minibatch can include a balanced training data set (e.g., the minibatch can include an equal amount of training images for each of a plurality of predetermined classifications.).

The second embedding can be processed with the classification model to generate a second classification. In some implementations, each second embedding of the plurality of second embeddings for the minibatch can be processed with the classification model to generate a plurality of second classifications. The second classifications can include a logit, a softmax output (e.g., the softmax layer output of the logit), and/or one-hot outputs (e.g., a binary prediction of whether the input includes the particular class or not).

In some implementations, the first input can include one or more first images, the second input can include one or more second images, and the first classification and the second classification can be image classifications.

The systems and methods can include determining a similarity measure between the first embedding and the second embedding based on feature similarity. In some implementations, the first embedding can include a first feature representation, the second embedding can include a second feature representation, and the feature similarity can be determined based at least in part on the second feature representation having one or more similar features to the first feature representation. In some implementations with a minibatch, the systems and methods can include determining one or more particular second embeddings are associated with the first embedding. The one or more particular second embeddings can then be used to determine a predicted classification for the first image. Determining the one or more particular second embeddings are associated with the first embedding can include determining a cosine similarity between the first embedding and each of the plurality of second embeddings (e.g., a cosine similarity between the feature representations). The one or more particular second embeddings can be the second embeddings with the highest similarity (e.g., the one or more particular second embeddings can include the second embeddings with a similarity score above a threshold score.). In some implementations, the one or more particular second embeddings can include the k-nearest neighbors to the first embedding.

In some implementations, the systems and methods can include evaluating a loss function based on the first classification, the second classification, and the similarity measure. For example, the loss function can include a loss term that evaluates a difference between the first classification and the second classification weighted by the similarity measure. Alternatively and/or additionally, for some implementations utilizing a minibatch for training, the systems and methods can include evaluating a loss function that evaluates a difference between the first classification and the predicted classification. The loss function can include a neighbor consistency regularization loss function. In particular, the neighborhood consistency regularization loss function can be configured to penalize the divergence of a predicted output classification (e.g., the first classification) of a particular embedding (e.g., the first embedding) from a weighted combination of predicted neighbor classifications for one or more neighboring embeddings (e.g., one or more particular second embeddings) to the particular embedding (e.g., the first embedding) in an embedding space. In some implementations, the loss function can include a bootstrapping loss function. The loss function may include a smoothness constraint. Additionally and or alternatively, the loss function can include a KL-Divergence loss function to measure the distance between two distributions. In some implementations, the neighbor consistency regularization loss function may provide smoothness and may provide for localized label propagation without the reliance of a global graph.

One or more parameters of the classification model can be adjusted based at least in part on the loss function.

Additionally and/or alternatively, the systems and methods can involve adjusting one or more parameters of the classification model based on a loss function evaluated based on a training label. For example, the training dataset can include a training label for the first input. The training label can be obtained and can be used to evaluate a second loss function that evaluates a difference between the first classification and the training label (i.e., a first input label, in which the first input label can include a respective label for the first input). In some implementations, the second loss function can include a cross entropy loss function. Additionally and/or alternatively, the loss function and the second loss function can be weighted portions of a combination loss function.

One or more parameters of the classification model can then be adjusted based at least in part on the second loss function.

In some implementations, the classification model and the encoder model can be jointly trained. Additionally and/or alternatively, the encoder model can be a newly initialized model. For example, in some implementations, the encoder model can include an initialized model without pretraining.

In some implementations, the systems and methods for training the classification model can occur during the scope of learning with noisy neighbors.

The systems and methods can involve adjusting the weights of the supervised learning loss and the neighbor consistency regularization loss based on the stage of learning. For example, the supervised learning loss may be more heavily weighted at the beginning of training, while the neighbor consistency regularization loss may receive increased weighting as more training passes occur. For example, the supervised learning loss can have reduced weighting as the feature extractor model becomes more refined. Additionally and/or alternatively, the combined loss function can include a linear combination of the neighbor consistency loss function and the supervised loss function. In some implementations, the combined loss function can further include a bootstrapping loss function. The activation function of the bootstrapping loss function can include one or more of a softmax, an argmax, or a softmax with a reduced temperature.

In some implementations, the logits of the classification model can include a classification, and a simplified embedding with reduced dimensionality. A contrastive loss can be evaluated based on the logits. In some implementations, the logits of the one or more machine-learned models can include one or more class prediction scores. The loss function(s) can be evaluated based on the logits, the softmax outputs, and/or one-hot outputs.

The training dataset for training the one or more machine-learned models can include labeled and unlabeled examples. The labeled examples may be utilized for supervised learning, and the classifications for the unlabeled examples may be inferred based on the information received from processing and training on the labeled examples. The unlabeled examples may be utilized to generate more nodes in the embedding space. In some implementations, the training dataset can include one or more noisy training labels.

In some implementations, selection of the neighbor representations (e.g., the one or more particular second embeddings) can include selection of the second embeddings with a threshold similarity score. The selected neighbors (e.g., the one or more particular second embeddings) may be weighted when generating the predicted classification and/or weighted for loss function evaluation. The weighting may be based on the similarity score for the respective embedding or may be based on a certainty score, or class prediction score, for that particular embedding. In some implementations, all selected neighbors (e.g., all of the one or more particular second embeddings) may be weighted the same for generation of the predicted classification and/or the loss function evaluation. Alternatively and/or additionally, the similarity values may be normalized such that the neighbor consistency regularization loss function remains a probability distribution. In some implementations, the self-similarity may be set to zero in order to not dominate the normalized similarity.

The systems and methods for training a classification model can train a classification model, which can then be utilized for one or more classification tasks. For example, the systems and methods can obtain input data. In some implementations, the input data can include image data.

The input data can be processed with an encoder model to generate an input embedding. In some implementations, the input embedding can include an embedding in an embedding space.

The input embedding can then be processed with the trained classification model to generate an output classification. In some implementations, the trained classification model may be trained with a loss function that includes supervised learning loss function variables and neighbor consistency regularization loss function variables.

The output classification can then be provided to a user computing device. The output classification can include one or more object classifications based on one or more features in the image data. In some implementations, the output classification can include a prediction score descriptive of a level of certainty for one or more possible classifications.

The systems and methods of the present disclosure provide a number of technical effects and benefits. As one example, the system and methods can provide a neighbor consistency regularization to mitigate the risk of overfitting caused by label-based training. More specifically, the systems and methods can adjust one or more parameters of the machine-learned model based on a neighbor consistency regularization loss function, which can penalize divergence from logits of similar feature representation classifications. For example, in some implementations, embedding neighbors can be used to generate a predicted classification to compare against an output classification. The neighbor consistency regularization can reduce the overfitting of label classifications.

Another technical benefit of the systems and methods of the present disclosure is the ability to train the classification model without a learned feature representation space. For example, the training can occur without the use of a global graph. In some implementations, the classifier of the classification model and the feature extractor of the encoder model can be trained jointly. The systems and methods disclosed herein can use localized unlearned embedding spaces for determining embedding neighbors.

Another example technical effect and benefit relates to improved computational efficiency and improvements in the functioning of a computing system. For example, the systems and methods disclosed herein can use localized label propagation without the use of a learned feature extractor or a learned global graph. The localized label propagation can remove the processing of the full global graph which can reduce the computational power needed for each training round. Moreover, the encoder model and the classification model can be trained jointly which can reduce the resource cost of having a pretrained feature extractor.

With reference now to the Figures, example embodiments of the present disclosure will be discussed in further detail.

### Example Devices and Systems

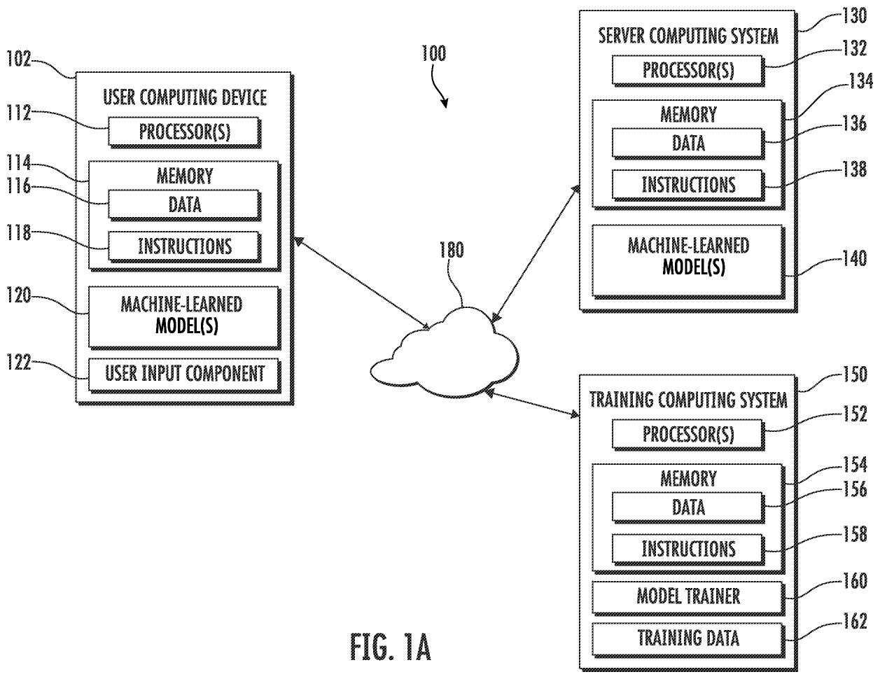

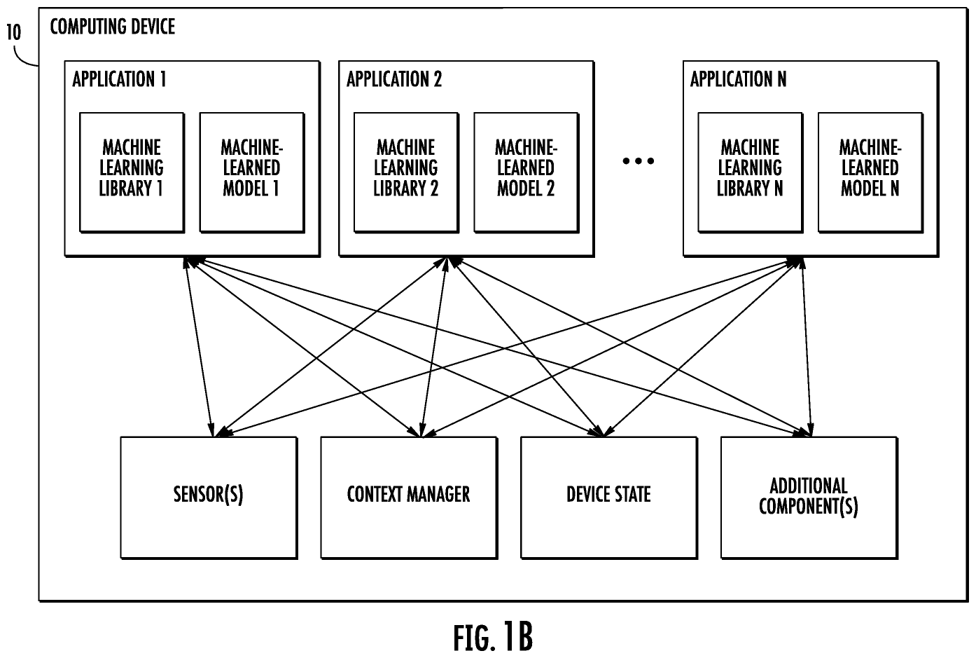

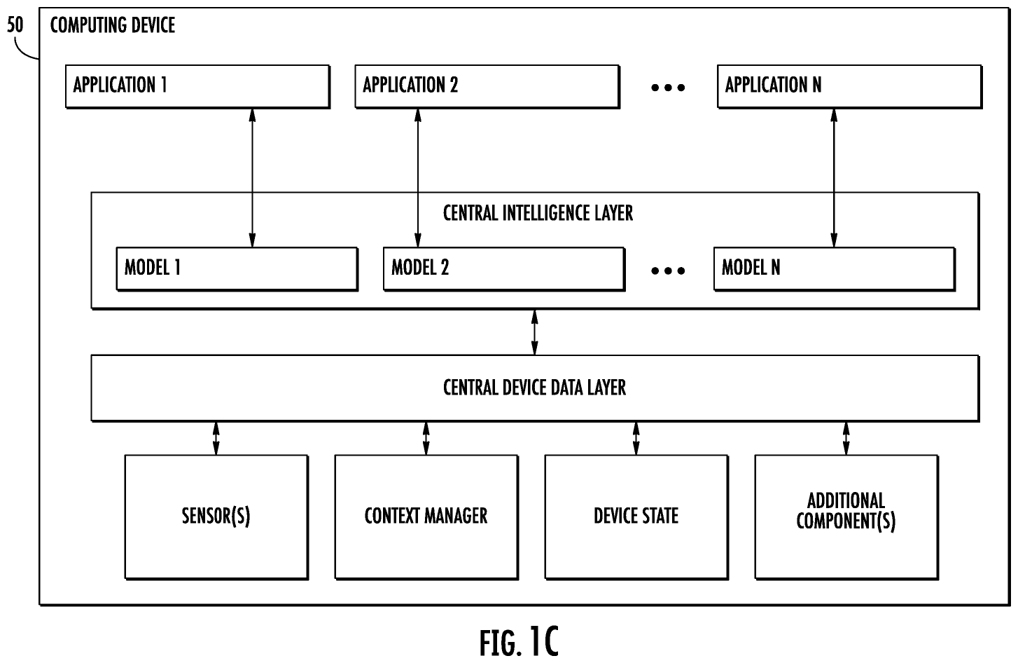

FIG. 1A depicts a block diagram of an example computing system 100 that performs classification model training according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

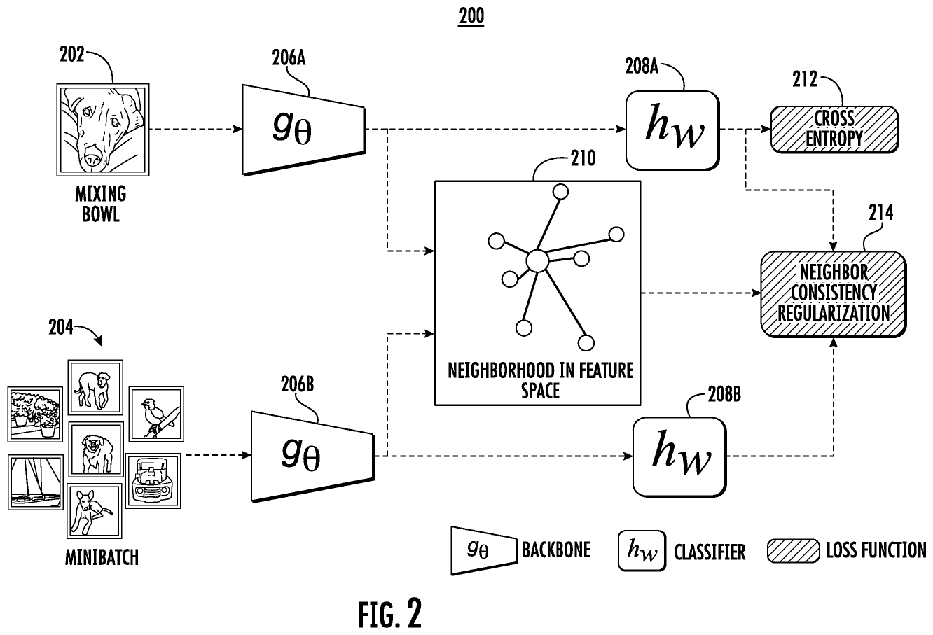

In some implementations, the user computing device 102 can store or include one or more classification models 120. For example, the classification models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example classification models 120 are discussed with reference to FIGS. 2-5 & 8.

In some implementations, the one or more classification models 120 can be received from the server computing system 130 over network 180, stored in the user computing device memory 114, and then used or otherwise implemented by the one or more processors 112. In some implementations, the user computing device 102 can implement multiple parallel instances of a single classification model 120 (e.g., to perform parallel classification model training across multiple instances of training datasets).

More particularly, the classification model can be trained with a combined loss function with a supervised learning loss and a neighbor consistency regularization loss. The trained machine-learned model(s) can then be utilized for a classification task. For example, the machine-learned model can include an encoder model and a classification model. An input can be processed by the encoder model to generate an embedding. The embedding can then be processed with the classification model to generate a classification (e.g., an image can be processed to generate an image classification and/or an object recognition classification.). The classification may include a logit, a softmax output, or a one-hot output.

Additionally or alternatively, one or more classification models 140 can be included in or otherwise stored and implemented by the server computing system 130 that communicates with the user computing device 102 according to a client-server relationship. For example, the classification models 140 can be implemented by the server computing system 140 as a portion of a web service (e.g., a classification model training service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned classification models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2-5 & 8.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the classification models 120 and/or 140 based on a set of training data 162. The training data 162 can include, for example, labeled and unlabeled examples. Moreover, in some implementations, the training data 162 can include one or more noisy label datasets. The training data can be utilized for label-based learning and for neighbor consistency regularization.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example training process 200 according to example embodiments of the present disclosure. In some implementations, the training process 200 can include obtaining a set of training data including a mixing bowl, or first input 202, and a minibatch 204 and, as a result of receipt of the training data, adjust one or more parameters of the classification model 208A and 208B based on the cross entropy loss 212 and the neighbor consistency regularization loss 214. Thus, in some implementations, the training process 200 can include an encoder model 206A and 206B that is operable to generate embeddings for neighbor determination and for processing by the classification model 208A and 208B.

The training process can include obtaining a training dataset including a first input 202, a respective first label, and a minibatch 204. The minibatch can include a plurality of second inputs. The first input 202 and the plurality of second inputs can include one or more images for each input. The first input 202 can be processed by an architecture backbone including an encoder model 206A in order to generate a first embedding. In some implementations, the first embedding can include a first feature representation generated with a feature extractor of the encoder model 206A. The first embedding can be processed with a classification model 208A to generate a first classification.

The minibatch 204 can be processed by an encoder model 206B in order to generate a second embedding for each respective second input. The encoder model 206B can be the same encoder model 206A the first input was processed with or may be a different model jointly trained with the other encoder model 206A. The plurality of second embeddings can then be processed with a classification model 208B to generate a plurality of second classifications (e.g., a second classification for each respective second embedding). The second classification model 208B may be the same as the classification model 208A or may be a different model jointly trained with the classification model 208A.

The training process 200 can include a neighborhood in feature space comparison 210. The neighborhood in feature space comparison 210 can include comparing the first embedding against each of the plurality of second embeddings to determine one or more particular second embeddings with feature similarity. The feature similarity can be a local embedding space association, which can be determined based on a cosine similarity, a Manhattan similarity, and/or a Jaccard similarity. The association can be determined without a global graph and may be determined without a learned feature representation space. The respective second classification for each of the respective one or more particular second embeddings can be processed to generate a predicted classification. The predicted classification can be descriptive of a neighborhood based classification.

The first classification, the predicted classification, and the respective first label can then be used to evaluate one or more loss functions. The loss function can include a cross entropy loss function 212 and a neighbor consistency regularization loss function 214. The cross entropy loss function 212 can be evaluated by comparing the differences between the first classification and the respective first label. The neighbor consistency regularization loss function 214 can be evaluated based on comparing the differences between the first classification and the predicted classification. The evaluation of the loss function can then be utilized to adjust one or more parameters of the classification model(s) 208A & 208B and/or one or more parameters of the encoder model(s) 206A & 206B. The cross entropy loss function 212 can be utilized for label-based training, and the neighbor consistency regularization loss function 214 can be utilized for neighborhood smoothing.

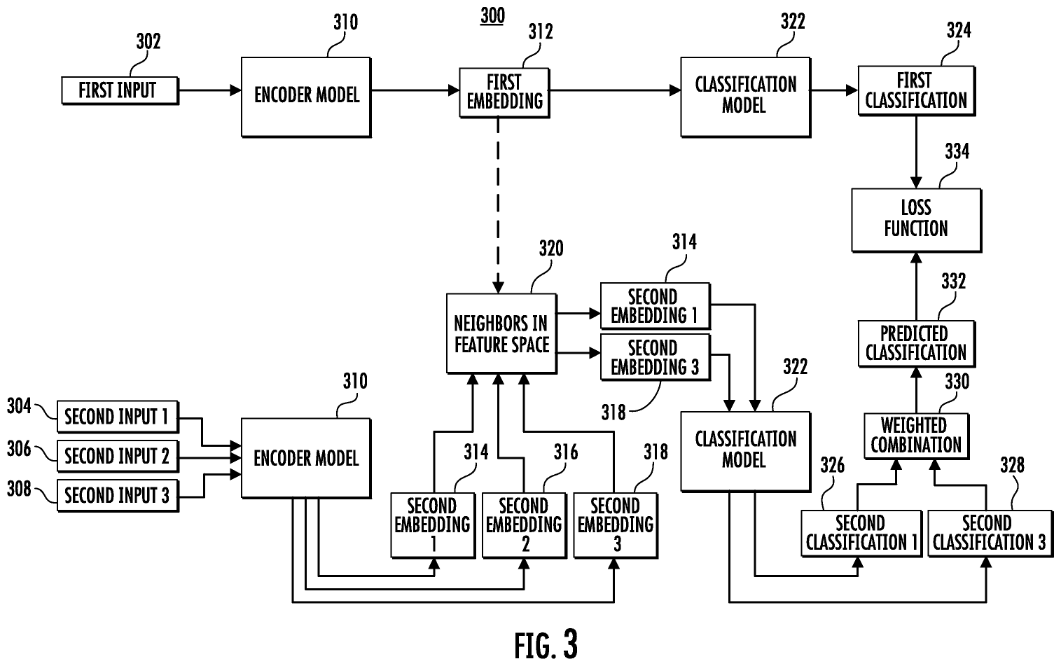

FIG. 3 depicts a block diagram of an example training process 300 according to example embodiments of the present disclosure. The training process 300 is similar to the training process 200 of FIG. 2 except that training process 300 focuses on systems and methods for neighbor consistency regularization.

More specifically, FIG. 3 depicts a training process 300 that includes a machine-learned model with an encoder model 310 and a classification model 322. The machine-learned model can be trained with a training dataset, which can include a plurality of examples. In some implementations, the plurality of examples can include a first input 302 (e.g., a first image) and a plurality of second inputs 304, 306, & 308 (e.g., a plurality of second images). In particular FIG. 3 depicts a first input and three second inputs 304, 306, & 308. The first input 302 and the three second embeddings 304, 306, & 308 can be processed with the encoder model 310 to generate a first embedding 312 and a plurality of second embeddings 314, 316, & 318 respectively. In some implementations the first embedding 312 can be processed with the second embeddings 314, 316, & 318 to determine the second embeddings with a threshold similarity to the first embedding 312. In the depicted example, two of the three second embeddings 314 & 318 are determined to be neighbors in the local feature space 320. The determination can involve determining the first embedding 312 and the particular second embeddings 314 & 318 share one or more features in their respective feature representations.

The first embedding 312 and the particular second embeddings 314 & 318 can then be processed with a classification model 322 to generate a first classification 324 and two particular second classifications 326 & 328 respectively. The two second classifications 326 & 328 can be processed with a weighted combination 330 to generate a predicted classification 332. In some implementations, each of the second classifications 326 & 328 can be weighted evenly or may be weighted based on the determined feature similarity, such that the classifications based on the most similar second embeddings may be weighted more favorably. Additionally and/or alternatively, the predicted classification 332 may be descriptive of the classifications of the embedding space neighborhood (e.g., the feature space neighborhood).

The first classification 324 and the predicted classification 332 can then be utilized to evaluate a loss function to generate a gradient descent, which can then be backpropagated to the classification model 322 and/or the encoder model 310. In some implementations, the loss function 334 can include a neighbor consistency regularization loss function. Additionally and/or alternatively, the loss function 334 can include a supervised learning loss function and a bootstrapping loss function. The backpropagated gradient descent can be utilized to adjust one or more parameters of the machine-learned model in order to train the model.

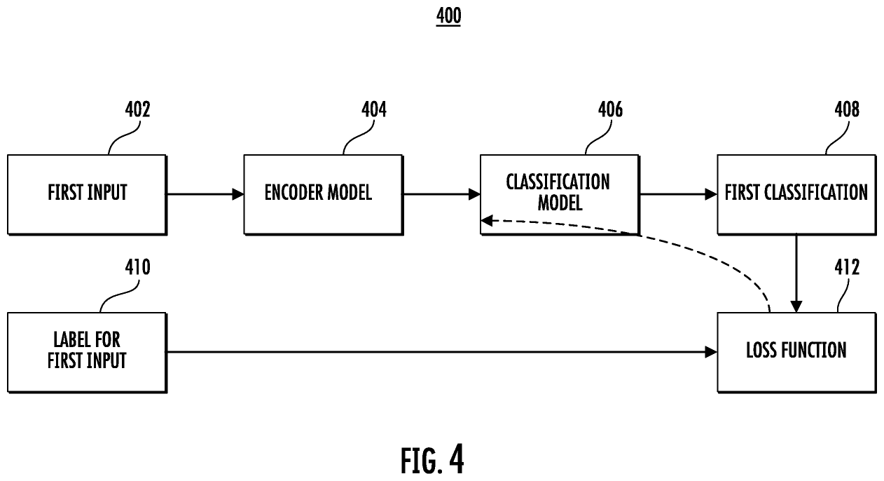

FIG. 4 depicts a block diagram of an example training process 400 according to example embodiments of the present disclosure. The training process 400 of FIG. 4 focuses on systems and methods for label-based learning. More specifically, the training process 400 can use an input 402 and a respective input label 410 for training one or more machine-learned models 404 and 406.

The training process 400 of FIG. 4 depicts an example label-based learning process. The training process 400 can include obtaining a training dataset, which can include a first input 402 and a label for the first input 410. The first input 402 can be processed with the encoder model 404 and a classification model 406 in order to generate a first classification 408. The first classification 408 can then be compared against the label 410 in order to evaluate a loss function 412. In some implementations, the loss function 412 can include a cross entropy loss function 412 and/or a supervised learning loss function. The loss function 412 may include a neighbor consistency regularization loss function and/or a bootstrapping loss function. The loss function 412 may generate a gradient descent based on the first classification 408 and the label 410. The gradient descent can then be backpropagated to the classification model 406 and/or the encoder model 404 in order to adjust one or more parameters of the machine-learned model(s).

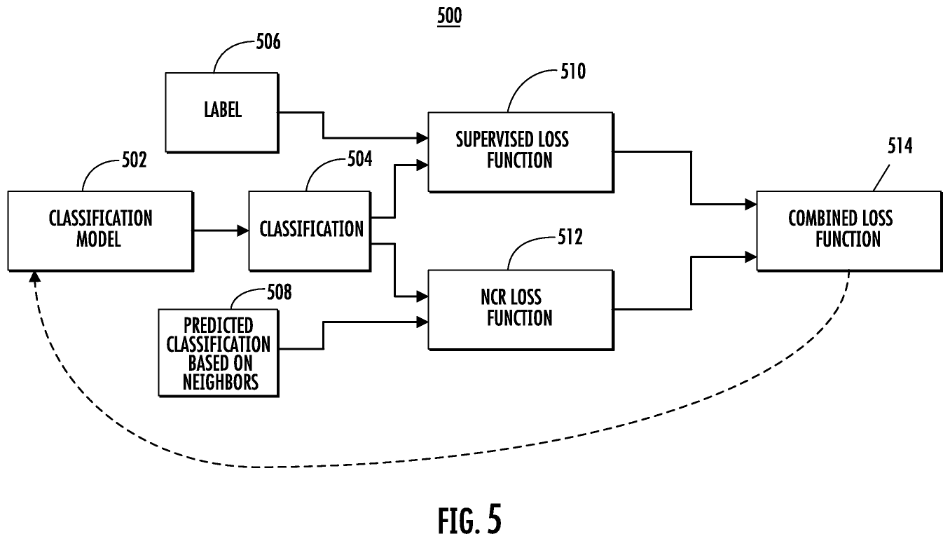

FIG. 5 depicts a block diagram of an example training process 500 according to example embodiments of the present disclosure. More specifically, the training process 500 of FIG. 5 uses a combined loss function 514 to mitigate overfitting and underfitting by training with both a supervised learning loss 510 and a neighbor consistency regularization loss 512.

The training process 500 of FIG. 5 as depicted includes a combined loss function 514 that can include a supervised loss function 510 and a neighbor consistency regularization (NCR) loss function 512. The training process 500 can include obtaining a training dataset. The training dataset can include an example. The example can be processed with an encoder model to generate a feature representation, and the feature representation can be processed with a classification model 502 to generate a classification 504 for the example. The classification can be utilized to evaluate a combined loss function 514 including a supervised loss 510 and a neighbor consistency regularization loss 512. The supervised loss 510 can be evaluated by comparing the classification 504 and the label 506 for the example. The neighbor consistency regularization loss 512 can be evaluated by comparing the classification 504 to a predicted classification 508 generated based on the example's embedding neighbors. The combined loss function 514 can involve a linear combination of the two loss functions 510 & 512. Additionally and/or alternatively, the combined loss function 514 can weight the supervised loss function 510 and the neighbor consistency regularization loss function 512 based on the stage of training, the similarity values of the neighbors, a classification confidence score, and/or the class prediction score for the classification 504. The evaluation of the combined loss function 514 can then be backpropagated to the classification model 502 in order to train the parameters of the classification model 502.

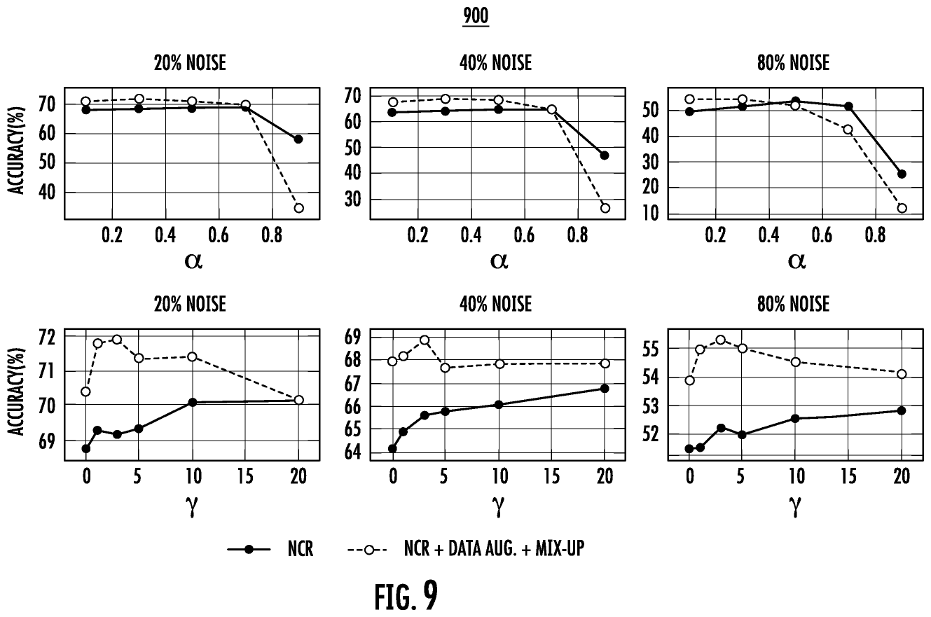

FIG. 9 depicts example model experimental results 900 according to example embodiments of the present disclosure. The experimental results 900 are conveyed via six line graphs. The top graphs depict the accuracy results of two example systems based on different a hyperparameters (i.e., the strength of the neighbor consistency term) and different noise proportions. The bottom graphs depict the accuracy results of two example systems based on different γ hyperparameters (i.e., neighbor selectivity) and different noise proportions.

### Example Methods

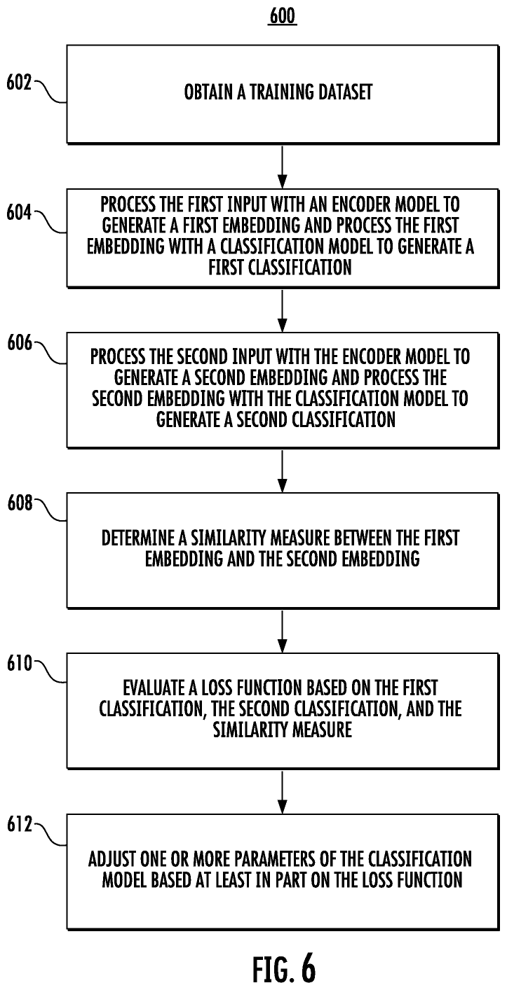

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain a training dataset. The training dataset can include a first input and a second input (e.g., the first input 302 and the second input 304 as shown in FIG. 3). The training dataset can further include a first input label descriptive of the classification for the first input. In some implementations, the first input and the second input can include one or more images.

At 604, the computing system can process the first input with an encoder model to generate a first embedding and process the first embedding with a classification model to generate a first classification. The encoder model can include a feature extractor, and the first embedding can include a first feature representation. In some implementations, the classification model can include a classifier. In some implementations, the encoder model can be a previously untrained encoder model. Additionally and/or alternatively, the encoder model can be an initialized model without pretraining, or a newly initialized model.

At 606, the computing system can process the second input with the encoder model to generate a second embedding and process the second embedding with the classification model to generate a second classification. In some implementations, the second embedding can include a second feature representation. The first classification and the second classification can include one or more class prediction scores descriptive of predicted classifications based on one or more features.

At 608, the computing system can determine a similarity measure between the first embedding and the second embedding. The similarity measure can include a determined feature similarity (e.g., a similarity value determined based on a cosine similarity).

At 610, the computing system can evaluate a loss function based on the first classification, the second classification, and the similarity measure. For example, the second classification and the similarity measure can be utilized to generate a predicted classification (e.g., the predicted classification 332 as shown in FIG. 3). The predicted classification and the first classification can be compared in order to evaluate the loss function (e.g., the loss function 334 as shown in FIG. 3). Alternatively and/or additionally, the loss function can include a loss term that evaluates a difference between the first classification and the second classification weighted by the similarity measure. In some implementations, the loss function may be evaluated based on a comparison of the first classification and the first input label. For example, the loss function can include a neighbor consistency regularization loss and a supervised learning loss. In some implementations, the neighbor consistency regularization loss and the supervised loss can be linearly combined and weighted to generate the loss function. The first classification and the second classification can include logits, softmax outputs from a softmax activation function, and/or one-hot predictions.

At 612, the computing system can adjust one or more parameters of the classification model based at least in part on the loss function. In some implementations, the classification model and the encoder model can be jointly trained. For example, both the encoder model and the classification model may be trained based on the loss function.

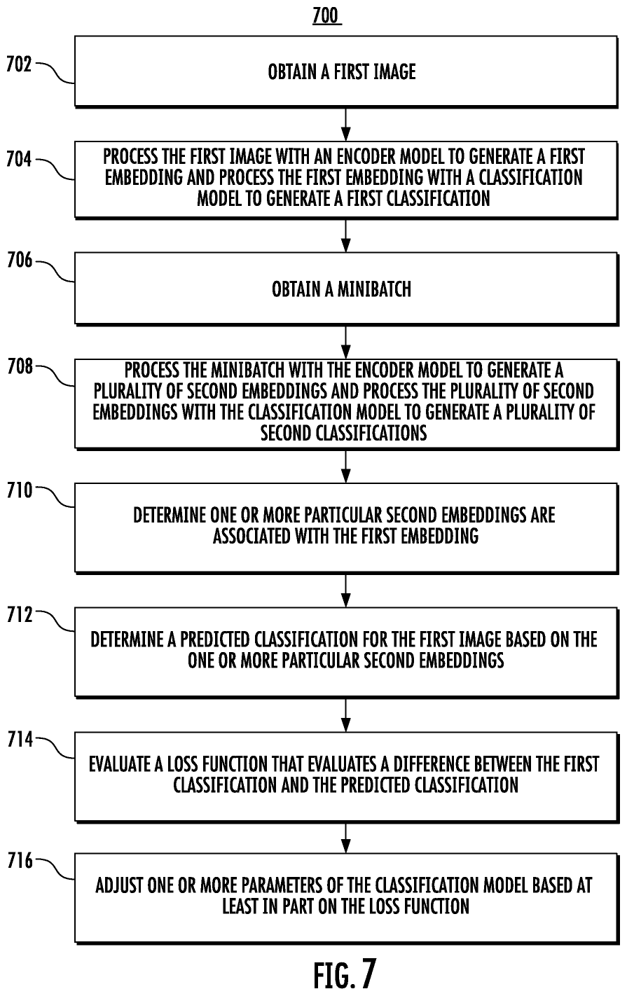

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain a first image. The first image can include one or more features. In some implementations, the first image can include one or more objects for classification or recognition (e.g., the first input 202 in FIG. 2 depicts a dog).

At 704, the computing system can process the first image with an encoder model to generate a first embedding and process the first embedding with a classification model to generate a first classification. The encoder model and the classifier model can be part of a larger machine-learned model. The larger machine-learned model can include a convolutional neural network or other image processing neural network, such as an attention-based neural network. In some implementations, the encoder model can include a feature extractor, and the classification model can include a classifier (e.g., the classifier 208A & 208B as depicted in FIG. 2). The feature extractor can be utilized to extract the one or more features of the first image in order to generate a first feature representation. The first classification can include an image classification and one or more object classifications. For example, an object classification including a class prediction score may be generated for each respective object in the first image.

At 706, the computing system can obtain a minibatch. The minibatch can include a plurality of second inputs (e.g., a plurality of second images, in which each of the second images includes one or more features (e.g., the minibatch 204 as depicted in FIG. 2).). The minibatch can be obtained by randomly selecting a plurality of training examples. In some implementations, the minibatch can be a balanced training dataset, in which an equal amount of training examples are selected for each classification.

At 708, the computing system can process the minibatch with the encoder model to generate a plurality of second embeddings and process the plurality of second embeddings with the classification model to generate a plurality of second classifications. The plurality of second embeddings can include a second embedding for each respective second image. Additionally and/or alternatively, the plurality of second classifications can include a second classification for each respective second embedding.

At 710, the computing system can determine one or more particular second embeddings are associated with the first embedding. The determination can be determined based on a cosine similarity between the first embedding and each of the plurality of second embeddings. In some implementations, an association can be determined based on the one or more particular second embeddings meeting a threshold feature similarity value. The one or more particular second embeddings can include second embeddings that include one or more overlapping (or same) features with the first embedding. In some implementations, the association can be determined by comparing the feature representation of the first embedding against the plurality of second feature representations of the plurality of second embeddings.

At 712, the computing system can determine a predicted classification for the first image based on the one or more particular second embeddings. The predicted classification can be determined based on the second classifications of the respective one or more particular second embeddings. In some implementations, the predicted classification can be determined based on a weighted combination of the classifications of the one or more particular second embeddings.

At 714, the computing system can evaluate a loss function that evaluates a difference between the first classification and the predicted classification. In some implementations, the loss function can include a neighbor consistency regularization loss (e.g., the neighbor consistency regularization loss function 214 depicted in FIG. 2), a cross entropy loss (e.g., the cross entropy loss function 212 depicted in FIG. 2), and/or a bootstrapping loss. In some implementations, the loss function can include a plurality of losses with varying weights based on one or more factors (e.g., classification certainty, stage of training, etc.). In some implementations, the loss function can be configured to penalize a divergence of the first classification of the first embedding from a weighted combination of predicted neighbor classifications for one or more neighboring embeddings to the first embedding in the embedding space. The first classification, the plurality of second classifications, and/or the predicted classification may include a logit (e.g., an unnormalized classification value), a normalized value (e.g., a softmax output descriptive of one or more classification probabilities), and/or a one-hot outputs (e.g., one-hot encoded vectors descriptive of binary values for one or more predefined classifications).

At 716, the computing system can adjust one or more parameters of the classification model based at least in part on the loss function. In some implementations, the classification model and the encoder model can be trained jointly.

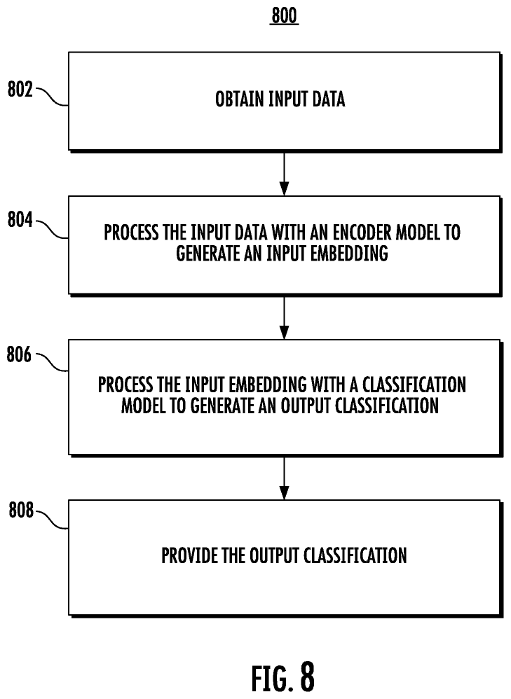

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain input data. The input data can include image data, audio data, textual data, and/or multimodal data.

At 804, the computing system can process the input data with an encoder model to generate an input embedding. The input embedding may be an embedding in an embedding space. In some implementations the input embedding can include a feature representation.

At 806, the computing system can process the input embedding with a classification model to generate an output classification. The classification model can be trained with a loss function, in which the loss function can include a supervised learning loss function and a neighbor consistency regularization loss function.

At 808, the computing system can provide the output classification. In some implementations, the output classification can include an image classification, an object classification, an audio classification, a speech classification, a natural language classification, a multimodal classification, and/or a topical classification.

### Example Implementations

In some systems, deep learning may utilize large, labelled datasets to train high-capacity models. However, collecting large datasets in a time-efficient and cost-efficient manner can often result in label noise (i.e., the presence of one or more labels that do not correctly identify the item(s) with which that label is associated). The systems and methods for learning from noisy labels that uses similarities between training examples in feature space disclosed herein can encourage the prediction of each example to be similar to its nearest neighbors. In some implementations, the systems and methods can include an inductive version of the classical, transductive label propagation algorithm and can operate online as a deep network is trained. In some implementations, the systems and methods can be complementary to other regularization methods, such as mix-up and label smoothing, which have been shown to be effective in presence of label noise. Furthermore, the systems and methods disclosed herein can achieve state-of-the-art performance for both synthetic and real label noise on mini-ImageNet for a wide range of noise ratios.

While deep learning can achieve unprecedented accuracy in image classification tasks, deep learning may rely on a large, supervised dataset that is often expensive to obtain. Unsupervised and semi-supervised learning seek to alleviate the large, supervised dataset requirement by incorporating unlabeled examples. However, the unsupervised and semi-supervised approaches may not be able to take advantage of the various sources of noisy labels, which are available in the modern world, such as images posted to social media under a given hashtag or images contained in webpages retrieved by a textual query. Training algorithms that are robust to label noise can therefore be highly attractive for deep learning.

Learning with noisy labels can include using the predictions of the model itself to reject or modify training examples. However, in some implementations, this approach can be inherently risky due to the ability of deep networks to fit arbitrary labels and may cause overfitting. Moreover, the approach may lead to complicated training procedures, such as maintaining multiple models or alternating between updating the model and updating the training set.

The systems and methods disclosed herein can include a neighbor consistency regularization (NCR) for the specific problem of learning with noisy labels. Rather than adopt model predictions as pseudo-labels, NCR can introduce an additional consistency loss that encourages each example to have similar predictions to its neighbors. In some implementations, the neighbor consistency loss can penalize the divergence of each example's prediction from a weighted combination of its neighbors' predictions, with the weights determined by their similarity in feature space. The motivation of NCR can be to enable incorrect labels to be improved or at least attenuated by the labels of their neighbors, by relying on the assumption that the noise is sufficiently weak or unstructured so as not to overwhelm the correct labels. Compared to the popular approach of bootstrapping the model predictions, NCR can be seen as instead bootstrapping the learned feature representation, which may reduce the system's and method's susceptibility to overfitting and improve the system's stability at random initialization.

Some existing systems may include label propagation algorithms for semi-supervised learning, which seek to transfer labels from supervised examples to neighboring unsupervised examples according to their similarity in feature space. However, the systems and methods disclosed herein can effectively perform label propagation online within mini-batches during stochastic gradient descent. The technique can result in a simple, single-stage training procedure. Moreover, whereas existing methods for label propagation can represent transductive learning in that they only produce labels for the specific examples which are provided during training, the systems and methods disclosed herein (e.g., NCR) can be understood as an inductive form of label propagation in that the systems and methods produce a model, which can later be applied to classify unseen examples.

The systems and methods disclosed herein can improve classification accuracy over a wide range of noise levels from both synthetic and realistic distributions. In some implementations, NCR can be complementary to common regularization strategies and can outperform methods which similarly seek to reduce the impact of incorrect labels through modification of the loss.

The systems and methods can include a neighbor consistency regularization, which can include a loss function for deep learning with noisy labels that encourages examples with similar feature representations to have similar labels. The neighbor consistency regularization can allow the systems and methods to obtain state-of-the art accuracy on the popular mini-Web Vision and mini-ImageNet-Red benchmarks containing realistic web noise.

For training a classification system, a dataset can be defined by X:={x₁, . . . , xₙ}. Each example (e.g., an image, xᵢ) can have a corresponding true label \tilde{y}ᵢ∈C. In some implementations, some of the labels, yᵢ, can be noisy: yᵢ≠\tilde{y}ᵢ and do not correctly reflect the visual content of the example xᵢ. During training, the systems and methods may not know whether yᵢ is noisy (yᵢ≠\tilde{y}ᵢ) or clean (yᵢ=\tilde{y}ᵢ). The goal of training can include learning a classification model with the highest accuracy on the true labels, \tilde{y}, even though an unknown number of labels in the training set may be noisy.

In some implementations, the systems and methods may train a convolutional neural network for classification (e.g., the encoder model 310 and/or the classification model 322 can be part of a convolutional neural network). The network, denoted by f_{θ,W}:X→ [symbol] ^{c}, can take a dataset example xᵢ as the input, and outputs logits, or class prediction scores. The convolutional neural network's two learnable parameters θ and W may correspond to the feature extractor and the classifier, respectively. The feature extractor can map an image xᵢ into a d-dimensional vector (i.e., vᵢ:=g_{θ}(xᵢ)∈ [symbol] ^{d}). The classifier can map the d-dimensional vector into class predictions scores (i.e., zᵢ:=h_{W}(vᵢ)∈ [symbol] ^{c}). In some implementations, the network parameters can be learned by minimizing a supervised classification loss function:

$${L}_{S} ( X , Y ; θ , W ) := \frac{1}{m} {\sum }_{i = 1}^{m} ℓ ( σ ( {z}_{i} ) , {v}_{i} ) , \qquad ( 1 )$$

where X and Y correspond to the set of examples in the mini-batch, m=|X|=|Y| denotes the size of the mini-batch, σ is the softmax function, and [symbol] (q,p) is the cross-entropy loss function for predictions q. When the target distribution p is a single label y∈C, the short-hand [symbol] (q,y)= [symbol] (q,δ_{y}) can be used for cross-entropy with a one-hot vector δ_{y}.

Label propagation can be a graph-based technique used in semi-supervised learning. The systems and methods can assume that the dataset includes labeled and unlabeled examples, and that the dataset can also be defined by a graph which is either given or created from the k-nearest neighbors of each example. The method can spread the label information of each node to the other nodes based on the connectivity in the graph. The process can be repeated until a global equilibrium state is achieved. Finally, the unlabeled examples can be assigned to the class which the model has received the most information from.

The label propagation may be defined formally as follows. Let us assume a graph can be created (or given) for a dataset X, and can be represented by an affinity matrix W, where Wᵢⱼ=similarity (xᵢ, xⱼ) can show that label propagation can be computed by minimizing the following objective,

$$Q ( F ) = \frac{1}{2} ( μ {\sum }_{i = 1}^{n} {‖ {F}_{i} - Y ‖}^{2} + {\sum }_{i , j = 1}^{n} {W}_{i j} {‖ \frac{1}{\sqrt{{D}_{ii}}} {F}_{i} - \frac{1}{\sqrt{{D}_{j j}}} {F}_{j} ‖}^{2} ) , \qquad ( 2 )$$

where D is the degree matrix (i.e., diagonal matrix where the (i,i) entry is the sum of i-th row of W), Y is a matrix containing one-hot label vector of each point in the dataset (i.e., Yᵢⱼ=1 if yᵢ=j and 0 otherwise), and μ is a regularization parameter. The objective function (2) may have two terms. The first term can be the fitting constraint which encourages the classification of each point to their assigned label. The second term in (2) may be the smoothing term, which encourages the output of nearby points in the graph not to change. Note that the objective (2) can also be written as a closed-form solution

$${F}^{*} = {( I - β {D}^{\frac{1}{2}} W {D}^{\frac{1}{2}} )}^{- 1} Y ,$$

where β=1/(1+μ) controls the probability of spreading information to the adjacent vertices in the graph.

One of the features of label propagation can be the transductive property. In transductive learning, the goal can be to classify seen unlabeled examples. This may be different than inductive learning, which learns a generic classifier to classify any unseen data. To apply label propagation on new test examples, a new graph W may need to be constructed each time a new test example is seen.

Label propagation can utilize a feature space that is fixed to compute the affinity matrix W. The fixed feature representation can be generated by a learned feature extractor, potentially from the noisy data. Some label propagation methods can involve alternating between optimizing the feature space and performing label propagation. However, the alternation may not directly enforce smoothness, as the optimization of two components are done separately.

The goal may be to overcome the issues of label propagation by 1) adapting label propagation to an inductive setting 2) applying the smoothness constraint directly during the optimization. The systems and methods can include a simple and efficient approach which generalizes label propagation by enforcing smoothness in the form of a regularizer. As a result, the systems and methods may avoid constructing an explicit graph to propagate the information, and inference can be performed on any unseen test example.

The systems and methods can include neighbor consistency regularization (e.g., the neighbor consistency regularization 214 of FIG. 2) and may generalize one or more aspects of the label propagation method.

When learning with noisy labels, the network may be prone to overfit, or memorize, the mapping from xᵢ to a noisy label yᵢ when minimizing the loss function (1). The overfitting behavior can result in a non-optimal classification performance in a clean evaluation set, as the network may not generalize well.

To overcome the overfitting issue, the systems and methods can include neighbor consistency regularization (NCR). The over-fitting can occur less dramatically before the classification layer h_{W}. Feature representations may be robust enough to discriminate between noisy and clean examples when training a network. With that assumption, the systems and methods can be designed with a smoothness constraint similar to label propagation (2) when training the network. The overview of one example method is depicted in FIG. 2.

The similarity between two examples can be determined by the cosine similarity of their feature representations (i.e., s_{i,j}=cos(vᵢ,vⱼ)=vᵢ^{T}vⱼ/(∥vᵢ∥ ∥vⱼ∥). The feature representations can contain non-negative values when obtained after a ReLU non-linearity, and therefore the cosine similarity can be bounded in the interval [0,1]. The systems and methods can be configured to enforce neighbor consistency regularization by leveraging the structure of the feature space produced by g_{θ} to enhance the classifier h_{W}. More specifically, h_{W}(vᵢ) and h_{W}(vⱼ) may behave similarly if s_{i,j} is high, regardless of their labels yᵢ and yⱼ. This may prevent the network from over-fitting to an incorrect mapping between an example xᵢ and a label yᵢ, if either (or both) yᵢ and yⱼ are noisy.

To enforce NCR, the systems and methods may be designed to include an objective function which minimizes the distance between logits zᵢ and zⱼ, if the corresponding feature representations vᵢ and vⱼ are similar:

$${L}_{S} ( X , Y ; θ , W ) := \frac{1}{m} {\sum }_{i = 1}^{m} {D}_{K L} ( σ ( {z}_{i} ) \vert \vert {\sum }_{j = 1}^{m} \frac{{s}_{i , j}^{γ}}{{\sum }_{k} {s}_{i , j}^{γ}} \cdot σ ( {z}_{j} ) ) , \qquad ( 3 )$$

where D_{KL} is the KL-divergence loss to measure the difference between two distributions. The hyperparameter γ may control the selectivity of the neighborhood. When γ=0, all the similarity values may become 1, and the consistency may be computed between xᵢ and all the other examples in the batch. Alternatively and/or additionally, higher γ may only retain the logits corresponding to the originally high similarity values. The systems and methods can normalize the similarity values such that the second term of the KL-divergence loss remains a probability distribution. The systems and methods may set the self-similarity s_{i,j}=0 such that it does not dominate the normalized similarity. In some implementations, softmax outputs and/or one-hot outputs may be used in place of, or in combination with, the logits for evaluating the loss and modifying one or more parameters of the machine-learned model(s).

The objective (3) may ensure that the output of xᵢ will be consistent with the output of its neighbors regardless of a potentially noisy label yᵢ. In some implementations, the systems and methods can combine the neighbor consistency regularization with the supervised classification loss function (1) (e.g., the combined loss function 514 of FIG. 5) to obtain the final objective to minimized during the training:

$$L ( X , Y ; θ , W ) := ( 1 - α ) \cdot {L}_{s} ( X , Y ; θ , W ) + α {L}_{N C R} ( X , Y ; θ , W ) , \qquad ( 4 )$$

where the hyper-parameter α∈[0,1] controls the impact of each loss term. In some implementations, the final loss objective (4) may have two terms. The first term may be the classification loss term Lₛ. The classification loss term can be analogous to the fitting constraint in (2). The second term may be the NCR loss L_{NCR}, which can be similar to the smoothness constraint in (2).

A difference between label propagation and some implementations of the systems and methods disclosed herein can be that label propagation applies smoothness based on the graph edges Wᵢⱼ computed over the entire dataset. On the other hand, the systems and methods may be online, and may not require a global graph W. In some implementations, the systems and methods may enforce the NCR through the local neighborhood as the feature space is being learned. As a result, the systems and methods may not require a learned feature representation with noisy examples. In some implementations, the systems and methods can enrich the learned feature representation by reducing the negative impact of noisy examples.

Label smoothing may be utilized as a regularization method, which mixes the ground truth labels with a uniform distribution over other possible labels in the dataset. For example, label smoothing may be utilized to denoise the label noise. Under label smoothing, the supervised classification function (1) can become:

$${L}_{L S} ( X , Y ; θ , W ) := \frac{1}{m} {\sum }_{i = 1}^{m} ( 1 - α ) \cdot ℓ ( σ ( {z}_{i} ) , {y}_{i} ) + α \cdot ℓ ( σ ( {z}_{i} ) , \frac{1}{C} 1 ) , \qquad ( 5 )$$

The linear combination of losses can be equivalent to a linear combination of labels due to the linearity of [symbol] (q,p) with respect to p.

When γ=0 in NCR (3), the systems and methods may enforce consistency between the output of xᵢ and every other sample in the batch equally. The process can be interpreted as a local variation of label smoothing. For example, the smoothing may not be applied uniformly over all possible set of classes, but done locally, based on the distribution of examples within the batch.

The bootstrapping loss can be introduced as an additional loss that adopts the model's predictions as labels. The overall loss may combine the supervised loss and the bootstrap loss in fixed proportion:

$${L}_{B} ( X , Y ; θ , W ) := \frac{1}{m} {\sum }_{i = 1}^{m} ( 1 - α ) \cdot ℓ ( σ ( {z}_{i} ) , {y}_{i} ) + α \cdot ℓ ( σ ( {z}_{i} ) , {σ}_{B} ( {z}_{i} ) ) , \qquad ( 6 )$$

where σ_{B} is the bootstrap activation function, which may be a softmax, an argmax, or a softmax with reduced temperature. NCR can be understood as bootstrapping from the neighborhood structure induced by the representation rather than from the model's actual predictions. In some implementations, the bootstrapping may eliminate or mitigate the dependency on the classifier parameters W, which may be particularly advantageous as it has been shown that linear models can fit random labels given a sufficiently high-dimensional representation.

The systems and methods can introduce a neighborhood consistency regularization for effective deep learning with label noise. In particular, neighbor consistency may compare favorably against label smoothing and the bootstrapping loss as a technique to temper the influence of incorrect labels. The systems and methods may include multi-stage training procedures for semi-supervised learning that may employ transductive label propagation; however, in some implementations, the systems and methods can include a comparatively simple training procedure, including an extra loss added to the objective which is optimized in stochastic gradient descent. NCR may be utilized to achieve state-of-the-art results on the mini-Web Vision dataset, outperforming methods that use neighbors in feature space purely for the purpose of rejecting mislabeled examples. In some implementations, the systems and methods can include coupling NCR with a technique to reject out-of-distribution examples and applying NCR to the problem of semi-supervised learning.

The systems and methods disclosed herein can include a method for learning image classifiers from noisy data. Image classification can be a general technology with a wide range of potential applications. Alternatively and/or additionally, the systems and methods disclosed herein can be utilized for a variety of classification tasks.

An example benefit of the systems and methods disclosed herein can be that the method is suited to learning from noisy data obtained by automatic scraping of the internet (e.g., the experiments on mini-ImageNet-Red and mini-Web Vision). Data collected with scraping may contain bias and a method which is able to more effectively learn from such data may inadvertently cause these biases to be amplified.

### Example Experimentation

The ability of the NCR model (e.g., the NCR model of FIG. 2) to handle different types of label noise can be evaluated using the mini-ImageNet-Red, mini-ImageNet-Blue, and mini-Web Vision datasets. Both mini-ImageNet-Red and mini-ImageNet-Blue can be constructed by adding label noise of varying ratios to the original mini-ImageNet dataset, which can include 50,000 training images and 5,000 validation images corresponding to 100 classes. This variant of mini-ImageNet cannot divide the classes into disjoint sets for training and testing.

Mini-ImageNet-Red can include realistic web noise, in which the noisy images were retrieved by searching for the class name as a web query and removing true-positive results. Mini-ImageNet-Blue can include synthetic noise, in which class labels are randomly flipped. Finally, mini-Web Vision can include realistic web noise similar to mini-ImageNet-Red, although in this particular case, the actual noise ratios in the training set may be unknown. For all datasets, the NCR model can be evaluated on a clean, human-verified test set.

ResNet-18 and ResNet-50 architectures can be used in the experiments. The training hyperparameters can include: training for 130 epochs with a batch size of 64 and learning rate of 0.1 decayed with a cosine learning rate schedule and using an SGD optimizer with momentum of 0.9 unless otherwise specified. While in some implementations it may be necessary to employ large batches or cross-batch memory for bigger datasets, these factors had a marginal impact for the datasets considered. A random crop augmentation can be employed during training in all experiments, and the images may be resized to 224×224 pixels. Moreover, each model may be trained on a single Nvidia V100 GPU and may release all code upon acceptance.

The first baseline (Standard) can include a ResNet model trained on the noisy labels with-out any training modifications. As additional regularization can be used to mitigate label noise by reducing a network's ability to fit arbitrary, spurious labels, networks trained with mix-up, additional data augmentation (in the form of random color jittering), and label smoothing can be considered. Furthermore, bootstrapping can be utilized as an additional baseline.

The ablation study can include first evaluating some of the key hyperparameters of NCR. Specifically, the impact of α can be studied, which controls the strength of the neighbor consistency term in (4), and γ, which controls the selectivity of the neighbors in (3).

To evaluate these hyperparameters, a held-out set can be created from the mini-ImageNet-Red dataset which includes the (clean) examples from the 0% noise dataset that do not appear in the datasets with 20%, 40% or 80% noise. A different model may be trained with each noise ratio separately, and its accuracy may be evaluated on the held-out set. The held-out set can allow for hyperparameters to be chosen without overfitting on the final evaluation set.

FIG. 9 depicts some experimental results of an example ablation study. Impact of hyperparameters α and γ are evaluated on a held-out set from the mini-ImageNet-Red dataset. In this implementation, the ResNet-18 architecture is used.

More specifically, FIG. 9 depicts the impact of α and γ for different noise ratios. A variant of NCR can be evaluated with additional regularizers (mix-up and data augmentation). FIG. 9 conveys that both α and γ behave similarly across different ratios for each variant of the example NCR method. However, the optimal values of α and γ may vary significantly between the two variants.

When NCR is combined with mix-up and data augmentation, the optimal values of both α and γ may be smaller. This can be explained by the hypothesis that the additional regularizers may result in a better representation, permitting the training procedure to place less emphasis on neighbor consistency (smaller α) and to use fewer, closer neighbors (smaller γ). In some implementations, α=0.3 and γ=3 may be fixed for all variants of the example NCR method in the following experiments.

Comparing NCR against the baselines can convey different advantages of the approach. The results can be reported on the official validation set of mini-ImageNet-{Red, Blue} datasets. Each experiment can be run five times and can report the mean accuracy at the completion of training. The peak validation accuracy attained during training may not be reported as this may lead to overfitting.

| | mini-Image Net-Blue | | | | mini-Image Net-Red | | | |
|---|---|---|---|---|---|---|---|---|
| Method | 0% | 20% | 40% | 80% | 0% | 20% | 40% | 80% |

Baselines

| | | | | | | | | |
|---|---|---|---|---|---|---|---|---|
| Standard | 65.8 ± 0.4 | 49.5 ± 0.4 | 36.6 ± 0.5 | 13.1 ± 1.0 | 63.5 ± 0.5 | 55.3 ± 0.9 | 49.5 ± 0.7 | 36.4 ± 0.4 |
| Data Aug. | 67.8 ± 0.3 | 52.7 ± 0.4 | 41.4 ± 0.8 | 25.4 ± 0.5 | 66.0 ± 0.4 | 59.9 ± 0.4 | 54.7 ± 0.4 | 41.1 ± 0.3 |
| Mix-Up | 67.4 ± 0.4 | 60.1 ± 0.2 | 51.6 ± 0.8 | 21.0 ± 0.5 | 65.5 ± 0.5 | 61.6 ± 0.5 | 57.2 ± 0.6 | 43.7 ± 0.3 |
| Label smoothing | 67.2 ± 0.3 | 56.9 ± 0.4 | 45.5 ± 0.3 | 16.6 ± 0.9 | 64.9 ± 0.5 | 61.1 ± 0.6 | 55.8 ± 0.7 | 41.4 ± 0.4 |
| Bootstrapping | 65.5 ± 0.4 | 53.0 ± 0.3 | 43.2 ± 0.3 | 0.6 ± 0.4 | 64.4 ± 0.5 | 56.7 ± 0.4 | 51.7 ± 0.5 | 38.3 ± 0.6 |
| DataAug. + MixUp | 69.7 ± 0.4 | 63.6 ± 0.4 | 55.9 ± 0.5 | 19.8 ± 0.7 | 67.3 ± 0.7 | 65.5 ± 0.3 | 61.6 ± 0.6 | 47.7 ± 0.4 |

Oracle

| | | | | | | | | |
|---|---|---|---|---|---|---|---|---|
| Standard | — | 63.9 ± 0.5 | 60.6 ± 0.4 | 45.4 ± 0.8 | — | 61.7 ± 0.1 | 58.4 ± 0.3 | 41.5 ± 0.5 |
| Data Aug. | — | 65.2 ± 0.4 | 62.4 ± 0.6 | 48.8 ± 0.7 | — | 63.5 ± 0.6 | 60.3 ± 0.2 | 45.5 ± 0.7 |
| DataAug. + MixUp | | 67.1 ± 0.3 | 64.0 ± 0.3 | 49.9 ± 0.5 | — | 65.5 ± 0.2 | 61.6 ± 0.2 | 47.3 ± 0.6 |

Neighbor Consistency Regularization

| | | | | | | | | |
|---|---|---|---|---|---|---|---|---|
| NCR - Standard | 67.8 ± 0.2 | 58.4 ± 0.5 | 47.9 ± 0.7 | 23.4 ± 0.4 | 65.0 ± 0.2 | 61.1 ± 0.3 | 56.3 ± 0.4 | 42.8 ± 0.6 |
| NCR - Data Aug | 69.4 ± 0.3 | 61.6 ± 0.2 | 52.8 ± 0.3 | 27.5 ± 0.8 | 67.6 ± 0.4 | 64.9 ± 0.2 | 60.7 ± 0.2 | 47.3 ± 0.3 |
| NCR - | 69.4 ± 0.4 | 64.6 ± 0.2 | 58.6 ± 0.3 | 16.0 ± 0.3 | 68.0 ± 0.3 | 66.9 ± 0.3 | 62.8 ± 0.2 | 48.6 ± 0.5 |
| DataAug. + MixUp | | | | | | | | |

Table 1 depicts a baseline and oracle comparison. Classification accuracy is reported on the mini-ImageNet-Blue and mini-ImageNet-Red datasets with the ResNet-18 architecture. The accuracy is reported for each individual noise ratio (0%, 20%, 40%, 80%). The mean accuracy and standard deviation is reported from five trials. The oracle model can be trained on only the known, clean examples in the training set using a cross-entropy loss.

More specifically, Table 1 conveys the final accuracy for each method on the mini-ImageNet-{Red, Blue} datasets across different noise splits. When compared with the standard baseline, the example NCR method significantly improves the performance, up to 15.1% across all noise ratios. Furthermore, the NCR method may be compatible with some of the existing baselines (e.g., mix-up and data augmentation). Combining the baselines with the NCR method can lead to further improvements in almost all scenarios.

NCR can improve the accuracy of the method even at 0% noise. The results can suggest that NCR has a general regularization effect. However, the improvement in accuracy may be much more pronounced in the training sets which contain label noise.

One exception, however, may be mini-ImageNet-Blue with 80% noise ratio. Example experimentation generated results that indicate the accuracy actually may go down when the certain implementations of the NCR method can be combined with mix-up and data augmentation. The results may occur due to over-regularization. Combining multiple regularizers, with the presence of uncorrelated synthetic noise, can lead to network underfitting. As a result, the evaluation accuracy may suffer. This behavior may not be observed on mini-ImageNet-Red with 80% noise ratio. Although this dataset also has a high amount of noise, the noise can be realistic and correlated (e.g., two breeds of dog are incorrectly labeled). Therefore, the network may still be able to learn visual patterns, even with additional regularization.

NCR can be compared against the oracle on Table 1. Oracle experiments can be conducted by removing all the noisy training examples from the dataset. The size of the training set may be reduced by 20%, 40% or 80% in this case. When the noise is realistic (mini-ImageNet-Red), the results can convey that NCR outperforms the oracle across all noise ratios when mix-up and additional data augmentation are used. The results can convey that the NCR method not only minimizes the negative effect of the noisy examples, but it can use them correctly to further enhance the model. However, the performance of some example NCR models may be significantly less than the oracle when the noise is synthetic (mini-ImageNet-Blue).

mini-ImageNet-Red

| Method | Network | 0% | 20% | 40% | 80% |
|---|---|---|---|---|---|
| D-Mix | R-18 | 55.8 | 50.3 | 50.9 | 35.4 |
| ELR | R-18 | 57.4 | 58.1 | 50.6 | 41.7 |
| MOIT | R-18 | 64.7 | 63.1 | 60.8 | 45.9 |
| NCR | R-18 | 68.0 ± 0.3 | 66.9 ± 0.3 | 62.8 ± 0.2 | 48.6 ± 0.5 |
| NCR | R-50 | 69.5 ± 0.7 | 68.9 ± 0.3 | 64.5 ± 0.3 | 49.0 ± 0.6 |

mini-WebVision

| Method | Network | Accuracy |
|---|---|---|
| ELR+ | Inception-Rv2 | 77.8 |
| LongReMix | Inception-Rv2 | 78.9 |
| GJS | R-50 | 79.3 ± 0.2 |
| D-Mix + c2D | R-50 | 79.4 ± 0.3 |
| NCR | R-50 | 80.4 ± 0.3 |

Table 2 depicts a comparison of the NCR method against existing methods. For example, a comparison of NCR against the state of the art with ResNet-18 and ResNet-50. The mean accuracy and standard deviation is reported from five trials.

Table 2 can compare NCR against the state of the art with ResNet-18 and ResNet-50 architectures on mini-ImageNet-Red and mini-Web Vision datasets. Table 2 conveys an up to 3.8% improvement on mini-ImageNet-Red with the NCR method using the ResNet-18 architecture. Accuracy may be further improved with ResNet-50. The improvements can be relatively smaller but consistent on mini-Web Vision. In some implementations, NCR can achieve higher performance compared to GJS, which can apply a similar consistency regularization only on different augmentation of each example. The experiment can confirm that the neighbor consistency brings further improvements on top of augmentation consistency.

Compared to standard training, NCR can incur an additional computational cost of order O(m²(d+c)) where m is the batch size, d is the feature dimension, and c is the number of classes. This arises in the computation of the similarity values and weighted predictions in (3). However, this operation can be relatively fast to compute for moderate values of m, because the method can include a dense matrix multiplication, for which modern GPUs are optimized.

| | |
|---|---|
| Baselines | NCR |

| | |
|---|---|
| Optimizer | SGD |
| Momentum | 0.9 |

| | | |
|---|---|---|
| Batchsize | 64 | 128 |
| Base Learning Rate | 0.1 | 0.05 |

| Learning Rate | |
|---|---|
| Schedule | cosine decay with linear warmup |
| Warmup epochs | 5 |
| Epochs | 130 |

Table 3 depicts a list of hyperparameters used to train the network in model experiments.

More specifically, Table 3 lists the hyperparameters used to train the network throughout baseline and NCR experimentation. The batch size can be increased by 2× for NCR to have a larger neighborhood for the similarity computation. However, the learning rate may be scaled by 2× in this case to have a similar behavior when learning the network.

The network may be trained with the typical dot-product linear classifier h_{W}( ) in all datasets except for mini-Web Vision. For the mini-Web Vision experiments, a cosine classifier may be used for h_{W}( ). The cosine classifier may also be a linear classifier, however, the features and the classifier weights may be [symbol] ₂-normalized unlike the dot-product classifier.

Mini-ImageNet-Red contains 50,000 training examples and 5,000 validation examples. The noisy images can be retrieved by text-to-image and image-to-image search. The noisy images can come from an open vocabulary outside of the set of classes in the training set. Depending on the noise ratio, a subset of clean images may be replaced by the noisy images to construct the training set.

Mini-ImageNet-Blue contains 60,000 training examples. The validation set can be the same as Mini-ImageNet-Red. In some implementations, the noise in Mini-ImageNet-Blue may be synthetic. The label of each example may be independently and uniformly changed according to a probability. The noisy examples can come from a fixed vocabulary (i.e., their true label belongs to another class in the training set).

Mini-Webvision contains a subset of the original Webvision dataset. The dataset can contain only the first 50 classes of the Google image subset. The subset can correspond to 65,944 training images. The validation set may contain 2,500 images corresponding to the 50 training classes.

Table 1 compares the NCR method to an oracle which excludes mislabeled examples on mini-ImageNet-Blue and mini-ImageNet-Red datasets. While the NCR method achieves higher accuracy than the oracle on mini-ImageNet-Red, the accuracy may be worse than the oracle on mini-ImageNet-Blue.

There are two key differences between the red and blue noise distributions which may explain the decrease in accuracy. Firstly, while every image in the blue noise belongs to one of the classes and therefore has a correct label, the red noise can include examples that do not belong to any class, referred to as out-of-distribution samples. Secondly, since the red noise is obtained by an internet search engine, red noise may contain images that are semantically related to the annotated class.

To analyze whether out-of-distribution images have a positive or negative impact, another dataset called mini-ImageNet-Purple may be generated. Mini-ImageNet-Purple may contain the same clean examples as the mini-ImageNet-Blue dataset, but the noisy examples may be different. Noisy examples may be retrieved by randomly selecting images from classes in ImageNet that are not present in mini-ImageNet. Thus, the noisy examples may be out-of-distribution samples, but the noise can still be synthetic and uniform.

| | mini-Image Net-Purple | | | |
|---|---|---|---|---|
| Method | 0% | 20% | 40% | 80% |

Baselines

| | | | | |
|---|---|---|---|---|
| Standard | 65.8 ± 0.4 | 16.1 ± 0.0 | 11.9 ± 0.0 | 0.05 ± 0.0 |
| Data Aug. | 67.8 ± 0.3 | 28.3 ± 0.0 | 23.2 ± 0.0 | 12.7 ± 0.0 |
| Mix-Up | 67.4 ± 0.4 | 35.4 ± 0.0 | 30.9 ± 0.0 | 14.3 ± 0.0 |
| DataAug. + MixUp | 69.7 ± 0.4 | 49.6 ± 0.0 | 42.6 ± 0.0 | 18.4 ± 0.0 |

Oracle

| | | | | |
|---|---|---|---|---|
| Standard | — | 63.9 ± 0.5 | 60.6 ± 0.4 | 45.4 ± 0.8 |
| Data Aug. | — | 65.2 ± 0.4 | 62.4 ± 0.6 | 48.8 ± 0.7 |
| DataAug. + MixUp | — | 67.1 ± 0.3 | 64.0 ± 0.3 | 49.9 ± 0.5 |

Neighbor Consistency Regularization

| | | | | |
|---|---|---|---|---|
| NCR - Standard | 67.8 ± 0.2 | 34.7 ± 0.0 | 25.9 ± 0.0 | 10.2 ± 0.0 |
| NCR - Data Aug | 69.4 ± 0.3 | 44.2 ± 0.0 | 33.3 ± 0.0 | 15.3 ± 0.0 |
| NCR - | | | | |
| DataAug. + MixUp | 69.4 ± 0.4 | 53.6 ± 0.0 | 43.1 ± 0.0 | 16.1 ± 0.0 |

Table 4 depicts an example baseline and oracle comparison. The classification accuracy can be determined based on the mini-ImageNet-Purple with the ResNet-18 architecture. The accuracy may be determined for each individual noise ratio (0%, 20%, 40%, 80%). The mean accuracy and standard deviation from five trials are displayed in Table 4. In some implementations, the oracle model can be trained on only the known, clean examples in the training set using a cross-entropy loss.

More specifically, Table 4 depicts the accuracy of NCR and the baselines in mini-ImageNet-Purple. When compared to mini-ImageNet-Blue (Table 1), the NCR and the baselines perform worse. The decrease in accuracy is true across all noise ratios. The experiment conveys that the presence of out-of-distribution examples may not improve the effectiveness of our method, and therefore may not account for the superior accuracy obtained on mini-ImageNet-Red compared to Blue.

The mislabeled images may also cause a decrease in accuracy. For example, the mislabeled images in mini-ImageNet-Red may be semantically similar to the annotated class, and thus contain useful information for learning despite being incorrect. The utility can be reflected in the baseline (Standard) results in Table 1 in that higher accuracy is obtained using mini-ImageNet-Red than mini-ImageNet-Blue when no strategy is employed to handle noisy labels. The improved accuracy may highlight a trade-off between the two types of noise distribution: while uncorrelated noise might be easier to detect, correlated noise is not as damaging.

Incorrect examples can be semantically similar to the annotated class even though the label is not strictly correct. For example, the noise distribution for “toucan” may contain images of other birds, and that of “dugong” may contain underwater images. The incorrect examples may also be visually similar to the correct examples, and therefore may assist the network to learn visual features that are correlated with the class.

The correlation of the incorrect examples with their annotated label may be the main reason for higher absolute accuracy in mini-ImageNet-Red. Table 1 conveys that the NCR method can make positive use of the correlated noisy data and can achieve higher accuracy performance than the oracle.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for training a classification model, the method comprising:
obtaining, by a computing system comprising one or more processors, a training dataset, wherein the training dataset comprises a first input and a second input;
processing, by the computing system, the first input with an encoder model to generate a first embedding;
processing, by the computing system, the first embedding with a classification model to generate a first classification;
processing, by the computing system, the second input with the encoder model to generate a second embedding;
processing, by the computing system, the second embedding with the classification model to generate a second classification;
determining, by the computing system, a similarity measure between the first embedding and the second embedding based on a feature similarity;
evaluating, by a computing system, a loss function, wherein the loss function comprises a loss term that evaluates a difference between the first classification and the second classification weighted by the similarity measure; and
adjusting, by the computing system, one or more parameters of the classification model based at least in part on the loss function.

2. The computer-implemented method of claim 1, further comprising:
evaluating, by the computing system, a second loss function that evaluates a difference between the first classification and a first label, wherein the first label comprises a respective label for the first input, and wherein the first label is obtained from the training dataset; and
adjusting, by the computing system, one or more parameters of the classification model based at least in part on the second loss function.

3. The computer-implemented method of claim 2, wherein the second loss function comprises a cross entropy loss function.

4. The computer-implemented method of claim 2, wherein the loss function and the second loss function are weighted portions of a combined loss function.

5. The computer-implemented method of claim 1, wherein the loss function comprises a neighbor consistency regularization loss function.

6. The computer-implemented method of claim 5, wherein the neighbor consistency regularization loss function is configured to penalize a divergence of a classification of a particular embedding from a weighted combination of neighbor classifications for one or more neighboring embeddings to the particular embedding in an embedding space.

7. The computer-implemented method of claim 1, wherein the first input comprises one or more first images, wherein the second input comprises one or more second images, and wherein the first classification and the second classification are image classifications.

8. The computer-implemented method of claim 1, wherein the classification model and the encoder model are jointly trained.

9. The computer-implemented method of claim 1, wherein the encoder model is a newly initialized model.

10. The computer-implemented method of claim 1, wherein the first embedding comprises a first feature representation, wherein the second embedding comprises a second feature representation, and wherein the feature similarity is determined based at least in part on the second feature representation comprising one or more similar features to the first feature representation.

11. The computer-implemented method of claim 1, wherein the second input comprises a minibatch comprising a plurality of training inputs; and
wherein generating the second embedding comprises:
processing the minibatch with the encoder model to generate a plurality of embeddings for the training inputs of the minibatch;
processing the plurality of embeddings for the training inputs of the minibatch with the classification model to generate a plurality of classifications for the training inputs of the minibatch;
determining one or more particular ones of the plurality of embeddings for the training inputs of the minibatch associated with the first embedding; and
determining the second embedding based on the one or more particular ones of the plurality of embeddings.

12. The method of claim 11, wherein determining the one or more particular embeddings for the training inputs of the minibatch associated with the first embedding comprises determining a cosine similarity between the first embedding and each of the plurality of embeddings for the training inputs of the minibatch.

13. The method of claim 11, wherein the minibatch comprises randomly selected training inputs from a training input database.

14. The method of any of claim 11, wherein the minibatch comprises a balanced training data set, wherein the minibatch comprises an equal amount of training inputs for each of a plurality of predetermined classifications.

15. The method of claim 1, wherein the loss function comprises a bootstrapping loss function.

16. The method of claim 1, further comprising:
obtaining a first input label; and
wherein evaluating the loss function comprises evaluating a difference between the first classification and the first input label, and wherein the one or more parameters are adjusted based at least in part on the first input label.

17. A computer-implemented method of classifying an input with a classification model, comprising:
obtaining input data;
processing the input data with an encoder model to generate an input embedding, wherein the input embedding comprises an embedding in an embedding space;
processing the input embedding with a classification model to generate an output classification, wherein the classification model was trained by:
obtaining a training dataset, wherein the training dataset comprises a first input and a second input;
processing the first input and the second input with an encoder model to generate a first embedding and a second embedding;
processing the first embedding and a second embedding with a classification model to generate a first classification and a second classification;
determining a similarity measure between the first embedding and the second embedding based on a feature similarity;
evaluating a loss function, wherein the loss function comprises a loss term that evaluates a difference between the first classification and the second classification weighted by the similarity measure; and
adjusting one or more parameters of the classification model based at least in part on the loss function; and
providing the output classification for the input data.

18. The method of claim 17, wherein the input data comprises image data, and wherein the output classification comprises one or more object classifications based on one or more features in the image data.

19. The method of claim 17, wherein the output classification comprises a prediction score descriptive of a level of certainty for one or more possible classifications.

20. (canceled)

21. A computing system, the computing system comprising:
one or more processors; and
one or more non-transitory computer-readable media that collectively store instructions that, when executed by the one or more processors, cause the computing system to perform operations, the operations comprising:
obtaining a training dataset, wherein the training dataset comprises a first input and a second input;
processing the first input with an encoder model to generate a first embedding;
processing the first embedding with a classification model to generate a first classification;
processing the second input with the encoder model to generate a second embedding;
processing the second embedding with the classification model to generate a second classification;
determining a similarity measure between the first embedding and the second embedding based on a feature similarity;
evaluating a loss function, wherein the loss function comprises a loss term that evaluates a difference between the first classification and the second classification weighted by the similarity measure; and
adjusting one or more parameters of the classification model based at least in part on the loss function.
